(19) United States
(12) Patent Application Publication
(10) Pub. No.: US 2025/0103064 A1
(43) Pub. Date: Mar. 27, 2025

(54) INTELLIGENT TASK ALLOCATION FOR DISTRIBUTED MOBILE MULTI-ROBOT SYSTEMS

(71) Applicant: Kabushiki Kaisha Toshiba, Tokyo (JP)

(72) Inventors: Xiaotao SHAN, Bristol (GB); Marius David JURT, Bristol (GB); Yichao JIN, Bristol (GB)

(73) Assignee: Kabushiki Kaisha Toshiba, Tokyo (JP)

(21) Appl. No.: 18/471,820

(22) Filed: Sep. 21, 2023

(51) Int. Cl. G05D 1/698

(52) U.S. Cl. CPC G05D 1/698

(57) ABSTRACT

Provided is a decentralised multi-robot task allocation method comprising: performing, by a first robot of a plurality of robots, the steps of: obtaining information regarding a new task comprising at least one single robot task, SRT, and at least one multi-robot task, MRT; determining which SRTs each remaining robot of the plurality of robots is likely to select; determining a preferred MRT for the first robot to perform, and potential coalition partners for performing the preferred MRT with the first robot; consulting with the remaining robots of the plurality of robots to determine a coalition of robots including the first robot to perform an MRT of the at least one MRT; and performing at least one of the at least one SRT or the at least one MRT based on the determination of which SRTs each robot from the subset of robots is likely to select, the determination of which MRTs each robot from the subset of robots is likely to select, and the consultation.

### FIELD

Embodiments relate to multi robot systems and particularly to task allocation within said systems.

### BACKGROUND

Multi-Robot Systems (MRS) have been widely used in warehouse automation. Human workers are replaced by some mobile automated guided vehicles (AGV). In this way, the efficiency of the warehouse can be significantly improved.

Previous studies have considered the Multi-Robot Task Allocation (MRTA) problem in the warehouse as a variant of the Vehicle Routing Problem (VRP), which involves transportation of distributed parcels between depots and final users. These studies assume that all parcels can be picked up and delivered by single robots of different sizes in the MRS. In addition, it is assumed that every robot can carry multiple parcels within its payload simultaneously, and thus the problem can be classified into a Multi-Task Robot, Single-Robot Task (MT-SR) problem. However, it would be expensive to design robots of different sizes to handle different-sized parcels. Additionally, the MRS may have different performances while dealing with different proportions of light and heavy parcels.

### BRIEF DESCRIPTION OF DRAWINGS

FIG. 1 is a flow diagram of a method of performing a task allocation.

FIG. 2 is a schematic diagram of an environment in which single robot tasks are allocated.

FIG. 3A is a schematic diagram of a journey plan for a robot performing a plurality of single robot tasks.

FIG. 3B is a schematic diagram of a journey plan for a robot performing a plurality of single robot tasks.

FIG. 4 is a flow diagram of steps performed by a leader robot in a single robot task allocation process.

FIG. 5 is a flow diagram showing an interaction between a leader robot and participating peer robots in a single robot task allocation process.

FIG. 6 is a flow diagram showing the steps performed by a peer robot in a single robot task allocation process.

FIG. 7 is a schematic diagram of an environment in which single robot tasks are allocated.

FIG. 8 is a flow diagram showing the steps performed by a leader robot in a multi-robot task allocation process.

FIG. 9 is a schematic diagram of an environment in which multi-robot tasks are allocated.

FIG. 10 is a flow diagram showing the steps performed by a leader robot in a multi-robot task allocation process.

FIG. 11 is a flow diagram showing the steps performed by a peer robot in a multi-robot task allocation process.

FIG. 12 is a flow diagram showing an interaction between a leader robot and participating peer robots in a multi-robot task allocation process.

FIG. 13 is a flow diagram showing an interaction between a leader robot and non-participating peer robots in a multi-robot task allocation process.

FIG. 14 is a schematic diagram of an environment in which single robot tasks and multi-robot tasks are allocated.

FIG. 15 is a schematic diagram of an example environment in which single robot tasks and multi-robot tasks are allocated.

FIG. 16 is a graph showing a comparison between a method according to an embodiment of the present invention and two different methods.

FIG. 17 is a graph showing a comparison between a method according to an embodiment of the present invention and two different methods.

FIG. 18 is a graph showing a comparison between a method according to an embodiment of the present invention and two different methods.

### DETAILED DESCRIPTION

According to embodiments there is provided a decentralised multi-robot task allocation method, and a multi-agent system configured to perform the method. The multi-robot task allocation method comprises: performing, by a first robot of a plurality of robots, the steps of: obtaining information regarding a new task comprising at least one single robot task, SRT, and at least one multi-robot task, MRT; determining which SRTs each remaining robot of the plurality of robots is likely to select; determining a preferred MRT for the first robot to perform, and potential coalition partners for performing the preferred MRT with the first robot; consulting with the remaining robots of the plurality of robots to determine a coalition of robots including the first robot to perform an MRT of the at least one MRT; and performing at least one of the at least one SRT or the at least one MRT based on the determination of which SRTs each robot from the subset of robots is likely to select, the determination of which MRTs each robot from the subset of robots is likely to select, and the consultation.

In an embodiment, an allocation of at least one of the at least one SRT or the at least one MRT to the robots in the plurality of robots may be broadcast to the plurality of robots.

In an embodiment, the first robot, instead of addressing all robots, may select a subset of robots from the plurality of robots, including the first robot, to participate in a task allocation process.

The method may further comprise performing, by the first robot, the steps of: requesting information on available time resources from the remaining robots of the plurality of robots; and selecting a subset of robots from the plurality of robots based on the available time resources of the remaining robot of the plurality of robots.

In an embodiment, information on the available time resources may be information that indicates whether a robot is available for performing new tasks or is estimated or predicted to become available within a predetermined period of time.

The method may further comprise performing, by the first robot, the steps of: requesting token information from the plurality of robots; and receiving a token, from a current token holder of the plurality of robots, indicating that the first robot is permitted to initiate task allocation.

The first robot may be configured to seek a new task in response to either the first robot having completed its assigned subtasks, or, if the first robot is in an idle state, in response to status of the other robots or tasks changing.

In an embodiment, only one robot from the plurality of robots can initiate task allocation at a given time.

In an embodiment, the current token holder may send the token to the robot that requests it first.

In an embodiment, determining which SRTs each robot from the remaining robots of the plurality of robots is likely to select may comprise: requesting preferred SRTs from the task from each of the plurality of robots; and receiving, from each of the subset of robots, information on the preferred SRTs from the task.

In an embodiment, Information on the preferred SRTs may include a calculated SRT profit.

In an embodiment, the determination of which SRTs each remaining robot of the plurality of robots is likely to perform may be based on information on the SRT, wherein the information on the SRT comprises at least one of: deadline information; weight; pick-up point; and delivery point.

In an embodiment, the selection of robots from the remaining robots of the plurality of robots to perform the at least one SRT may comprise an iterative process of matching each SRT to a robot, wherein in each iteration, at most one SRT is assigned to each robot.

In an embodiment the SRTs are matched with each robot based on weighted bipartite matching according to the profit calculation of each robot.

In an embodiment, the preferred SRTs for each robot may be determined based on a profit calculation performed by each respective robot.

In an embodiment, the determination of which MRT and coalition partners the first robot is likely to select may comprise requesting a preferred MRT, a profit calculation for the preferred MRT, and preferred coalition partners for the preferred MRT from each of the plurality of robots.

In an embodiment, consulting with the remaining robots of the plurality of robots may comprise: sending an invitation to each robot of the plurality of robots comprising a preferred MRT, a required coalition partner, and an MRT profit; receiving a suggestion of an alternative MRT for the first robot to perform; and adding the alternative MRT to the preferred MRTs for the first robot to perform.

In an embodiment, the method may further comprise executing an MRT, wherein the MRT is only executed if each robot required to be part of the coalition accepts an invitation to execute the MRT.

In an embodiment, the method may further comprise performing, by each of the remaining robots of the plurality of robots: responding to the invitation of the first robot by: (i) accepting the invitation, (ii) rejecting the invitation, or (ill) providing a suggestion of an alternative MRT for the first robot to perform, wherein the suggestion of an alternative MRT to perform includes at least one of a previously unsuggested MRT yielding higher profits than for the preferred MRTs of the first robot, an optimal coalition for performing 10 the alternative MRT, including the first robot and the robot providing the suggestion, or an associated profit value for the alternative MRT.

A Task AlloCation with multi-robot Coalition (TACTIC) method is disclosed. In this method, the collective transport and capacitated vehicle routing problems are addressed in combination to enable greater efficiency of delivery in a dynamically changing environment. When addressing both problems simultaneously, new issues arise, such as how to combine the solutions to the ST-MR and MT-SR problems, when to execute Single Robot Tasks (SRTs) and when to execute Multi-Robot Tasks (MRTs), and how to reduce the computational complexity. An SRT is a task which can be completed by a single robot. An MRT is a task which requires multiple robots cooperating to complete it.

### Overall Operation Structure

An environment may include a plurality of autonomous agents (e.g. robots) that are configured to perform a task comprising at least one SRT and at least one MRT. The plurality of autonomous agents collectively form a multi-agent system. The at least one SRT and at least one MRT are considered to be sub-tasks of the task for the purposes of this disclosure. The environment may be a dynamically evolving environment where new tasks and sub-tasks are added over time. An embodiment is described wherein the SRTs and MRTs involve distributing parcels from one location to another. However, a skilled reader will readily appreciate that the teaching could be applied to other scenarios, for example, coordinating distribution of supplies in a disaster zone.

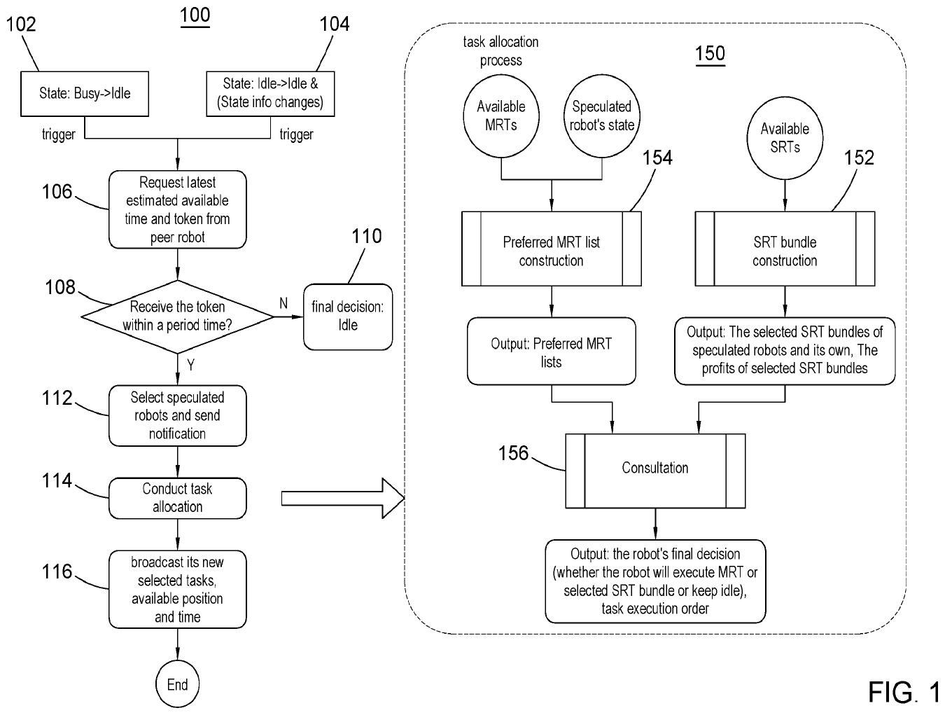

The optimisation goal of the proposed method is to minimise the time needed to finish all of the sub-tasks and minimize the deadline missing ratio. Each robot's decision-making process is depicted in FIG. 1.

The left hand side 100 of FIG. 1 shows the method steps performed by a robot in order to become a leader robot, and the processes performed by the robot once it has been assigned the role of leader robot. The right hand side 150 of FIG. 1 within the dashed lines shows the method steps performed by a leader robot in a task allocation process.

For a given robot, the task allocation process can be initiated under two circumstances:

(1) the robot completes its existing assigned sub-tasks and transitions from a busy mode to an idle mode 102. When it has entered an idle mode, it seeks out new tasks for its next trip.

(2) the robot maintains an idle state while the state information of other robots or tasks changes 104. The predicted available time and location are included in state information for each robot, indicating when and where the robot can complete a specified task and/or all currently assigned subtasks.

The initial phase in the task allocation process is to request the most recent information regarding expected available time resources and tokens from peer robots 106. During the execution of assigned sub-tasks by each robot, the estimated available time resources are always subject to change because of the environment's dynamic nature. In a trip, we assume robots can carry multiple light parcels within their payload or collectively participate in one MRT. Additionally, robots may need to pick up all the parcels before transporting them to designated delivery points.

To avoid sub-task selection conflicts, only one robot at a time can initiate the task allocation process. To ensure that this requirement is met, the system provides a single token that is passed from robot to robot as required to hand over responsibility for task allocation. Only the robot that possesses the token is permitted to select a task. Therefore, a robot must request the token from the current token holder prior to initiating the task allocation process 108. The possessor of a token will send it to the first robot that requests it. If the robot does not receive the token within a certain period, the final decision will be for the robot to return to an idle state 110. The token exchange is beneficial as a current token holder may already be performing a task, and so may be unable to participate in a new task allocation process.

After receiving the token, the robot will function as a leader robot and select at most Np robots who are also currently available for performing new tasks or who are estimated or predicted to become available within a predetermined period of time, and inviting them to take part in the subsequent task allocation process 112. During the process of task allocation, the leader robot will determine which tasks other robots would preferably select to prevent greedy selection 114. Not all robots will engage in the determination process. In particular, only robots who are currently available for performing new tasks or who are estimated or predicted to become available within a predetermined period of time are included in the determination process, since it makes less sense to speculate on the behaviours of peer robots whose available time resources are far in the future based on the tasks currently available. If such robots were to participate in the task allocation, additional tasks may arise before such robots became available to perform the current tasks, and so an optimal solution for allocating such additional tasks may not be reached. The leader robot therefore selects a subset of robots from the robots in the environment to participate in the task allocation process, including itself. The selection of the subset of robots is based on the time allocation resources of each robot in the environment. The leader robot may select the peer robots with time resources most similar to those of the leader robot to be in the subset of robots, in particular robots who are currently available for performing new tasks or who are estimated or predicted to become available within a predetermined period of time.

The task allocation procedure has three components: an SRT bundle construction process 152, a preferred MRT list construction process 154, and a consultation process 156.

During the SRT bundle construction process 152, the leader robot determines which SRTs robots from the subset of robots will preferably select, and the profit for executing these SRTs. Currently unassigned SRTs are used as the input for the SRT bundle construction process.

The leader robot first sends a profit calculation request to the participating robots, i.e., the robots in the subset of robots. Initially all the participating robots including the leader robot participate in the SRT allocation process. The leader robot calculates the profit for itself to execute the current available SRTs. The same process happens in the participating robots after receiving the SRT profit calculation request. Each robot will select those SRTs whose profit is above 0 as preferred SRTs. When the participating robots finish profit calculation, they send the calculation result to the leader robot.

The output of the SRT bundle construction process comprises the chosen SRT bundles of the leader robot and each of the subset of robots. The output also comprises, for each robot of the subset of robots, a profit indication for each task, as well each robot's own preferred task execution order.

A preferred MRT list construction process 154 is used to select robot coalitions to execute the MRTs. A profit is calculated to determine the best robot coalitions to execute the MRTs in the task. The input to the MRT list construction process is currently unassigned MRTs and participating robots' states (estimated available time resources and available position). Both the leader robot and the participating peer robots are configured to build their own preferred MRT list.

First the leader robot sends a request to the participating peer robots to conduct an MRT profit calculation. Then, the leader robot conducts a calculation process to determine its own preferred MRTs. To determine its own preferred MRTs, the leader robot considers all available MRTs and calculates a weighted distance (defined in Equation 6) for each MRT. The weighted distance is a measure of the robot's personal preference for MRTs to perform. The leader robot then selects the top ranked MRTs as preferred MRTs for the leader robot to perform. For every preferred MRT, the leader robot then calculates the benefits of different combinations of coalitions of robots (containing the leader robot itself) to execute it. The best coalition and profit value is stored for that MRT. After the MRT profit calculation, the preferred MRT list is sorted according to the profit calculation. A corresponding calculation process is also conducted by each of the participating robots after receiving the MRT profit calculation request.

The SRT bundle construction 152 and preferred MRT list construction 154 may be conducted in parallel.

The consultation process 156 is performed by the leader robot in conjunction with the participating robots to assist the leader robot in deciding whether to: execute an MRT with a selected coalition of peer robots; execute an SRT bundle; or remain idle, and to assist the leader robot in allocating the remaining SRTs and MRTs. As shown in FIG. 1, this process takes the results of the SRT bundle construction processes and preferred MRT list construction process as inputs. The profits calculated for executing the MRT and SRT bundles respectively serve as benchmarks for each other, balancing the selection between MRTs and SRTs for the subset of robots in the following trip. If the final decision for the state of the leader robot is not to return to an idle state, the leader robot broadcasts its selected tasks, required partners and updated estimated available time resources and position to its peers after making the final decision 116. After receiving the information, the peer robots update their information about the leader robot. Peer robots that have been asked to participate in a MRT add the subtask (MRT) to their list of tasks to be completed behind the current assigned and unfinished subtasks. Additionally the peer robots update their estimated available time resources and position.

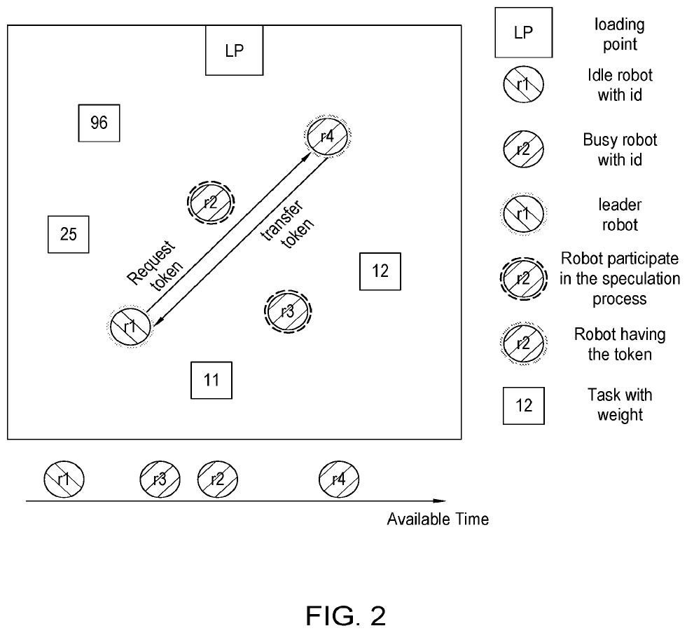

FIG. 2 shows an example application scenario. There are three busy robots and one idle robot. We assume that robot r1 has just finished all of its assigned tasks, thus changing its state from busy to idle. In order to acquire more tasks, it requests latest estimated available time and token information from the peer robots, r2, r3, and r4. It receives a notification from robot r4 indicating that robot r4 currently has the token. Robot r1 then requests the token from robot r4. After acquiring the token, robot r1 begins to select robots who are currently available for performing new tasks or who are estimated or predicted to become available within a predetermined period of time. The number of possible participating robots including the leader robot in this case is fixed to 3. Thus, the robots r2 and r3 are selected as participating robots. The robot r1 becomes the leader robot and sends a notification to robots r2 and r3.

### SRT Bundle Construction

The SRT bundle construction process of the leader robot is performed to determine which SRTs its peer robots might choose and to build its own SRT bundle.

In this process, the profit calculation process is distributed to all the participating robots. Each participating robot is responsible for calculating its own profit to be gained from executing each of the selected SRTs. The leader robot gathers all the profit calculation results and performs weighted bipartite matching to allocate SRTs to the respective robots. Through this method, the computation of the SRT bundle construction process is distributed amongst the subset of robots.

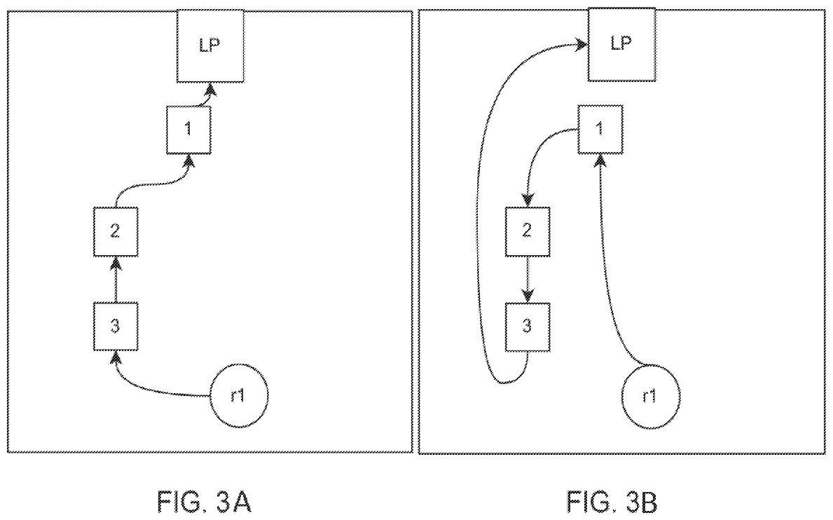

In the proposed method, a bundle of SRTs is selected for each robot, and so a plan can be determined for a whole trip of each selected robot. There are two reasons for this. Firstly, planning for the whole trip for each robot can have better results than planning solely for each robot's next action. As shown in FIGS. 3A and 3B, SRT allocation without planning for the whole trip may cause a longer travelling distance, even if the robot chooses to execute the same SRTs. The proposed method considers the task execution order while calculating the profit to execute a bundle of SRTs, which ensures the shortest path for executing selected SRTs and better SRT choices are selected. In addition, since in every trip we assume that a robot can execute either SRTs within maximum payload or an MRT, and so, in order to balance the selection between them, the profit for executing SRTs in a subsequent trip is calculated.

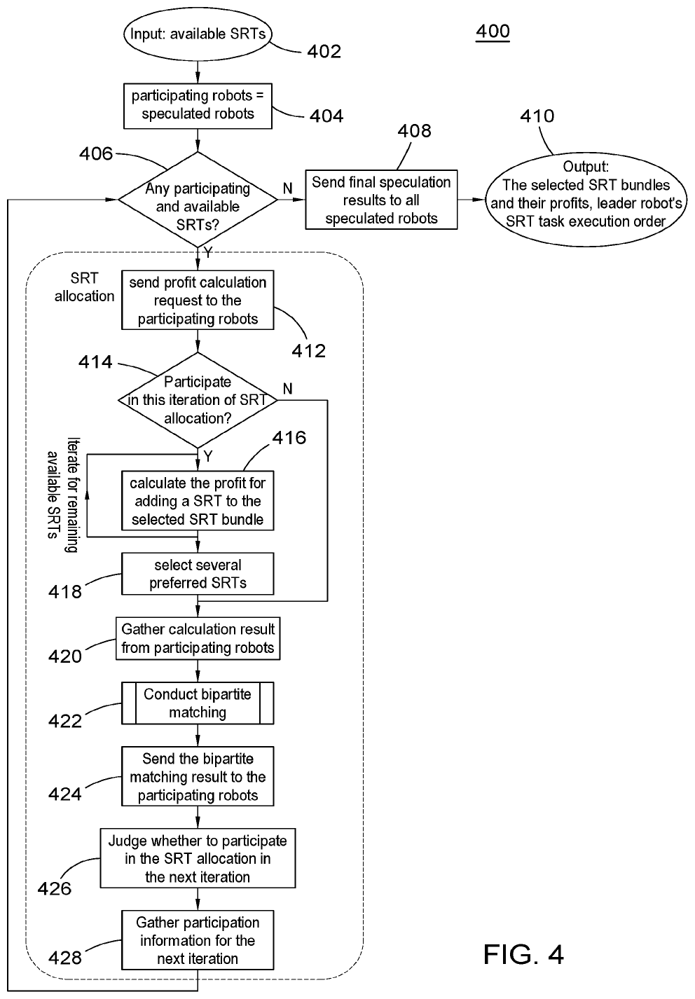

FIG. 4 shows the SRT bundle construction process 400 of the leader robot r1. The input 402 is the information of each SRT including its deadline, weight, pickup point, and delivery point. The SRT bundle construction process comprises several rounds of SRT allocation 414. In every iteration 414, each participating robot is allocated at most one SRT by the leader robot. Since a robot has limited payload, a robot cannot participate in the SRT allocation process when its remaining payload is lower than the minimum weight of the remaining available SRTs. The leader robot, however, even if it cannot be allocated more SRTs to perform, may still gather profit calculation results from other participating robots 420 and perform the task allocation. The SRT bundle construction process ends when no robot has enough remaining payload to execute one more SRTs, or when there are no further unassigned SRTs 406.

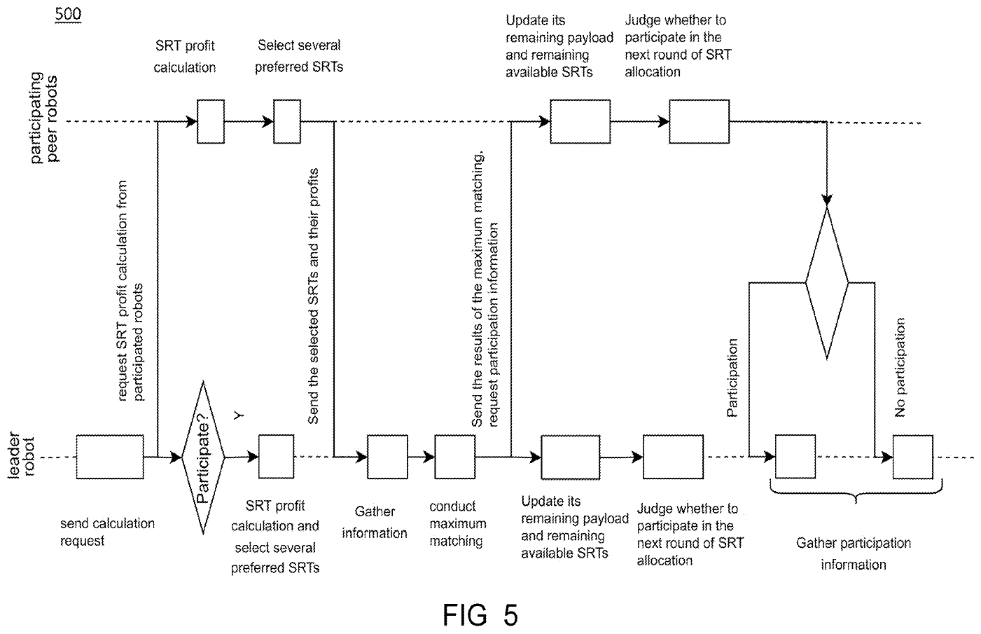

FIG. 5 shows the interaction 500 between the leader robot and participating peer robots in the SRT allocation process. The leader robot requests SRT profit calculation results from the participating robots. The participating robots perform an SRT profit calculation and select their preferred SRTs. The participating robots send the results of the preferred SRTs and their profits to the leader robot. The leader robot also performs an SRT profit calculation and selects its preferred SRTs. The leader robot gathers the information regarding the preferred SRTs from the participating robots and conducts weighted bipartite matching, e.g. Hopcroft Karp algorithm. The leader robot then sends the results of the weighted bipartite matching to the participating peer robots and requests participation information. Each of the participating robots, including the leader robot, then updates its remaining payload and the remaining available SRTs. Each robot then judges whether to participate in the next iteration of the SRT allocation, and sends an indication to the leader robot. The leader robot gathers the information and keeps performing the SRT allocation until no robot has enough remaining payload to execute one more SRTs, or when there are no further unassigned SRTs.

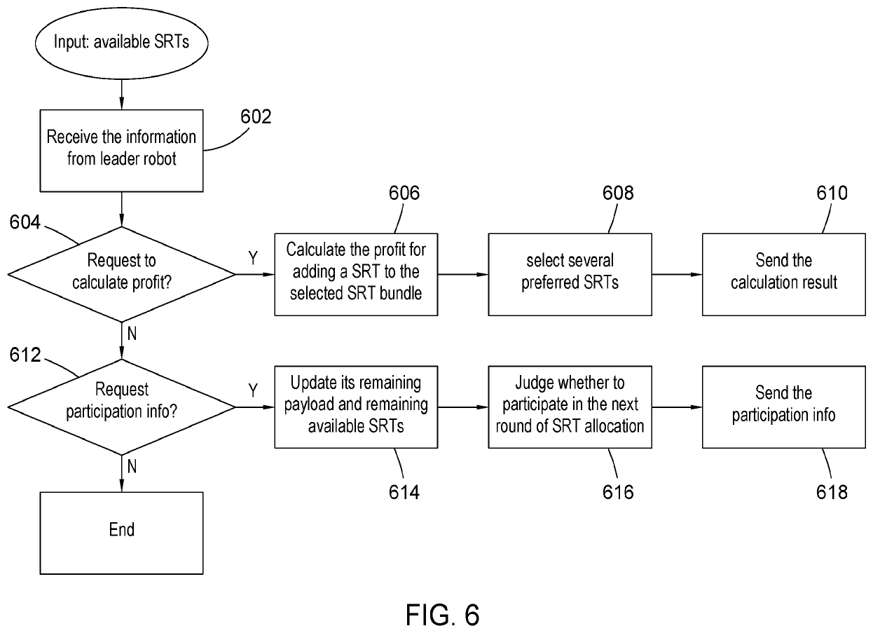

FIG. 6 shows how the participating peer robots react to the information sent by the leader robot. First, the leader robot sends a profit calculation request to the participating robots 602. Initially all the participating robots including the leader robot participate in the SRT allocation process. Then the leader robot calculates the profit for itself to execute the current available SRTs, which, in a non-limiting example, can be expressed by equation 2. The same process is performed by the participating peer robots after receiving the SRT profit calculation request 604. Each robot selects those SRTs whose profit is above 0 as its preferred SRTs 610. When the participating robots finish profit calculation they send the calculation result to the leader robot 610. After gathering calculation results from the peer robots, the leader robot constructs a weighted bipartite graph according to the profit calculation result. A weighted bipartite matching algorithm such as Hopcraft-Karp can be chosen to allocate SRTs to robots, whose optimisation goal is expressed by equation 1. Next, the leader robot sends the determination results to every participating robot and requests participation information from the participating robots 612. The participation information indicates whether a robot will participate in an SRT allocation process. Then the leader robot updates its own remaining payload, and updates a list of remaining available SRTs, according to the weighted bipartite matching result. It decides whether to participate in the next iteration of SRT allocation by comparing its remaining payload with the minimum weight requirement of the remaining available SRTs. That is, the leader robot must have sufficient remaining payload to perform the SRT with the minimum parcel weight in order to participate in the next round of SRT allocations. The same process happens in the participating peer robots after they receive the participation information request 614. After gathering participation information, the leader robot initiates the next round of SRT allocation. If there is no available SRT or no robot has sufficient remaining payload to execute one more of the remaining SRTs, the leader robot calculates the profit of executing the selected SRT bundle for every participating robot according to equation 5 and broadcasts the profit to all the participating robots. The profit value acts as an input to the MRT allocation process.

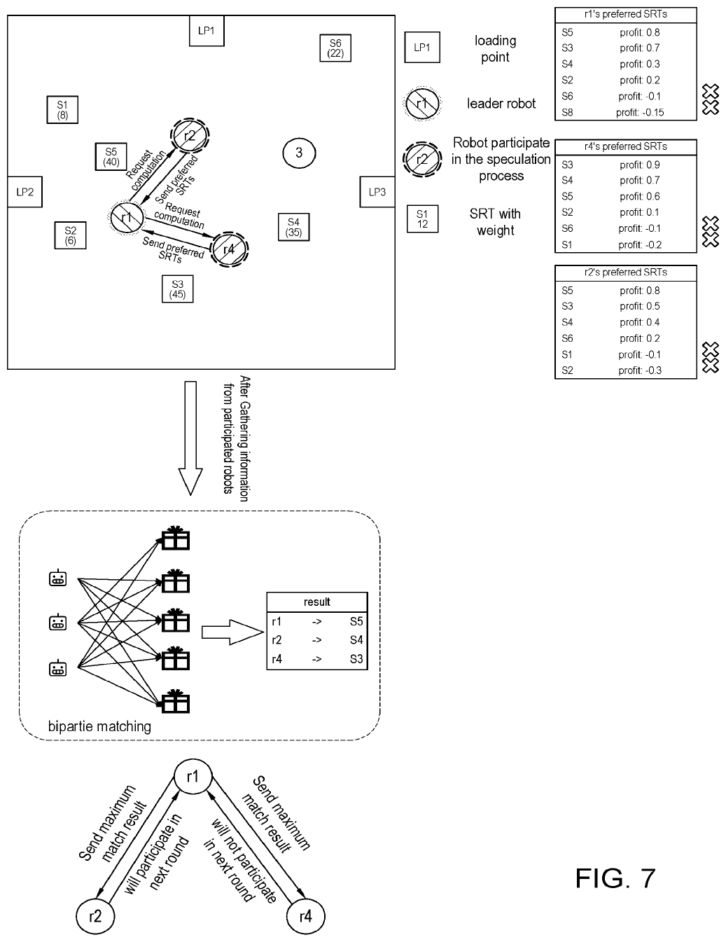

FIG. 7 shows an example of first round of SRT allocation. The leader robot is r1. The participating robots are r2 and r4. The payload of each robot is assumed to be 50 kg. First, robot r1 sends requests the robots r2 and r4 to calculate the profit for performing the SRTs. As shown in equation 2, the profit is related to the travelling distance, remaining time and weight of an SRT in one embodiment. The profit is a measure of the benefit of performing a given task. The SRT profit calculation result is shown in FIG. 7. Each robot will only keep those SRTs whose profit is above 0 as their preferred SRTs. After the leader robot has gathered calculation results from participating peer robots, it constructs a bipartite graph and performs weighted bipartite matching. The determination result is r1->s5, r2->$4, r4->s3. Robot r1 then sends the determination result to r2 and r4, so that they know which SRTs have been selected and which SRTs are assigned to them. The robots update their remaining payload based on the weighted bipartite matching result. The remaining payload of robot r1 is 10 kg, which is larger than the SRT s2 whose weight of 6 kg is the minimum weight among remaining available SRTs. Thus, robot r1 will participate in the next round of SRT allocation. As for robot r4, its remaining payload is 5 kg, which is less than the weight of s2, and so it will send no participation response to the leader robot. Similarly, after comparison, robot r2 will send a participation response to robot r1.

The optimisation goal of the weighted bipartite matching process is shown in equation 1.

$$max {\sum }_{{r}_{i} ∈ PR} profitSRT ( {r}_{i} , {t}_{k} , {B}^{i} ) \qquad ( 1 )$$

$$( 2 )$$

$$profitSRT ( {r}_{i} , {t}_{k} , {B}^{i} ) = \frac{significance ( {t}_{k} ) * {w}_{k}}{{rp}_{i}} - \frac{distance ( {B}^{i} ⋃ {t}_{k} ) - distance ( {B}^{i} )}{{v}_{i} * NF}$$

$$significance ( {t}_{k} ) = \{ \begin{matrix}{k}_{1} & if {rt}_{k} > NF * {k}_{3} \\ {k}_{1} + ( {k}_{2} - {k}_{1} ) \text{?} & otherwise\end{matrix} \qquad ( 3 )$$

$$distance ( {B}^{i} ) = \text{?} {\sum }_{{p}_{m} ∈ {P}_{B}} {\sum }_{{p}_{n} ∈ {P}_{B}} {x}_{{p}_{m} {p}_{n}}^{i} ‖ {p}_{m} , {p}_{n} ‖ \qquad ( 4 )$$

$$profitBundle ( {r}_{i} , {B}^{i} ) = \text{?} ( significance ( {t}_{k} ) * \frac{{w}_{k}}{p \_ i} ) - \frac{distance ( {B}^{i} )}{\text{?} * NF} \qquad ( 5 )$$

$$\text{?} \text{indicates text missing or illegible when filed}$$

PR is the set of robots selected by the leader robot to participate in the task allocation process, including the leader robot. x denotes that a robot, i, decides to reach pₙ after reaching pₘ.

Equation 2 is used to calculate the profit for robot rᵢ to finish SRT tₖ. It considers the robot's travelling distance, remaining payloads, speed, tasks' weight, position, and remaining time. wₖ is the weight of task tₖ, rpᵢ is the remaining payload of robot rᵢ, vᵢ is the average velocity or speed of robot rᵢ, NF is a normalisation factor which is used for scaling. The determination of this factor depends upon the size of the scenario and the speed of the robots. Equation 3 is related to the remaining time of task tₖ which can represent the significance of finishing the task tₖ. The parameter k₃ constrains the impact of remaining time on the profit since the value of the significance(tₖ) function may reduce the impact of tasks' positions on equation 2. k₁ and k₂ can be seen as initial and supplementary stimuli for executing the SRT. They are factors used for adjusting the initial value of significance(tₖ) and the value of significance(tₖ) based on the influence of the remaining time of a task respectively. These two parameters can be optimised through an optimisation algorithm, e.g. a genetic algorithm. rₖ is the remaining time of task k. distance (B) is calculated through equation 4 which is used to calculate the shortest distance to finish an SRT bundle Bⁱ, where P_{B}={p₀, p₁ . . . pₙ} is the position set which contains the initial position of the robot, pickup and designated delivery points of all SRTs in the task bundle Bⁱ. ∥pₘ,pₙ∥ is the Euclidean distance between pₘ and pₙ. The search space of finding the shortest distance is small. For one thing, a robot's payload limits the maximum number of tasks it can execute. It is also assumed that robots pass all the pickup points before driving to the delivery points. Optimisation algorithms such as Brute Force, Simulated Annealing, Branch and Bound, or others can be used to find the best task execution order. Equation 5 is to calculate the profit for robot n to execute SRT bundle Bⁱ.

### Preferred MRT List Construction

The preferred MRT list construction process is used to select preferred MRTs from the available MRTs and to calculate the profit for the best robot coalitions to execute them.

Both the leader robot and the participating robots are configured to build their own preferred MRT list.

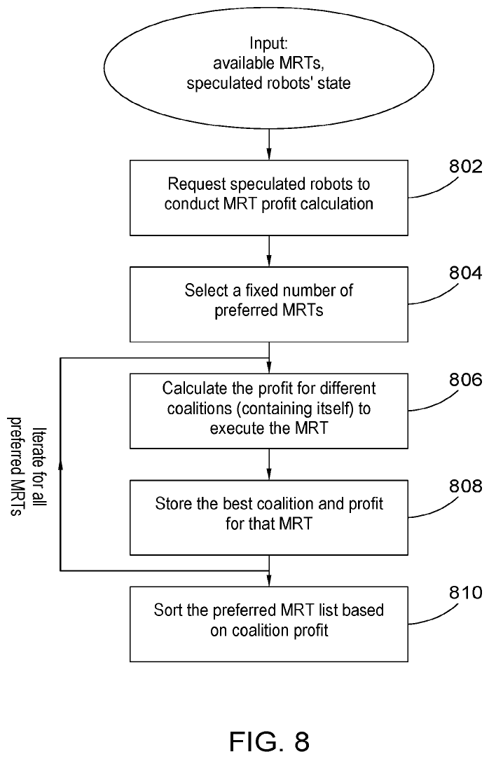

FIG. 8 shows the process of the preferred MRT list construction process under the leader robot. The input to the MRT list construction process includes the currently unassigned MRTs and the participating robots' states (estimated available time and available position). First the leader robot sends a request to the participating peer robots to conduct MRT profit calculation 802. Then, the leader robot conducts the calculation process. First, it considers all available MRTs and calculates the weighted distance, WDₖ, for each MRT, tₖ, according to equation 6, where p₀ is the robot's available position, and p₁ is the pickup point of task tₖ. significance(tₖ) is calculated according to equation 3.

$${WD}_{k} = \frac{‖ {p}_{0} , {p}_{1} ‖}{significance ( {t}_{k} )} \qquad ( 6 )$$

The weighted distance reveals the leader robot's personal preference. The leader robot will then select the top ranked MRTs as preferred MRTs 804. For every preferred MRT, benefits of different combinations of coalitions (containing the leader robot itself) to execute it is calculated 806. The profit for a coalition to execute an MRT is shown in equation 8. The best coalition and profit value is stored for that MRT 808. After the MRT profit calculation has been performed, the preferred MRT list is sorted according to the profit 810. Each MRT whose profit is below 0 is eliminated from the preferred MRT list. The same calculation process is also conducted in the participating peer robots after receiving the MRT profit calculation request.

Equation 7 is used to calculate the profit for a robot n executing MRT tₖ with partners in coalition Cₖ. WT indicates how long a robot i needs to wait for other robots within coalition Cₖ at the pickup point of task k. This is calculated according to Equation 10. The profit for the coalition Cₖ to execute MRT tₖ can be expressed by Equation 8.

$$profitMRT ( {t}_{k} , {r}_{i} , {P}_{k}^{i} , {C}_{k} ) = significance ( {t}_{k} ) * {k}_{4} - \frac{duration ( \text{?} )}{NF} * {k}_{5} - \frac{WT ( \text{?} )}{NF} * {k}_{6} \qquad ( 7 )$$

$$profitCoalition ( {t}_{k} , {C}_{k} , {P}_{k} ) = \frac{\text{?} profitMRT ( \text{?} )}{\text{?}} \qquad ( 8 )$$

$$duration ( {P}_{k}^{i} ) = \frac{\text{?}}{\text{?}} \qquad ( 9 )$$

$$WT ( {r}_{i} , {C}_{k} , {P}_{k}^{i} , {ST}_{k} ) = \text{?} ( s \text{?} + \frac{\text{?}}{\text{?}} ) - ( s \text{?} + \frac{\text{?}}{\text{?}} ) \qquad ( 10 )$$

$$\text{?} \text{indicates text missing or illegible when filed}$$

Pⁱₖ={p₀, p₁, p₂} refers to the position set of robot n executing MRT tₖ, p₀ refers to the initial position of robot rᵢ; p₁ and p₂ refer to the pickup and delivery points of MRT tₖ respectively. Equation 9 is used to calculate the time taken for a robot rᵢ to reach the pickup point p₁. Cₖ is the robot set participating in the MRT tₖ. Equation 10 is used to calculate the waiting time among robots in the coalition Cₖ. Equation 11 is used to calculate the arrival time for robot rᵢ to reach pickup point p₁. Assuming MRT tₖ is in robot rᵢ's sₖⁱ tour, the start time of the tour sⁱₖ is stⁱₖ. The significance(t) is the same as Equation 3. Values k₄, k₅, k₆ are used to adjust the impact of remaining time, distance, and waiting time on the profit value.

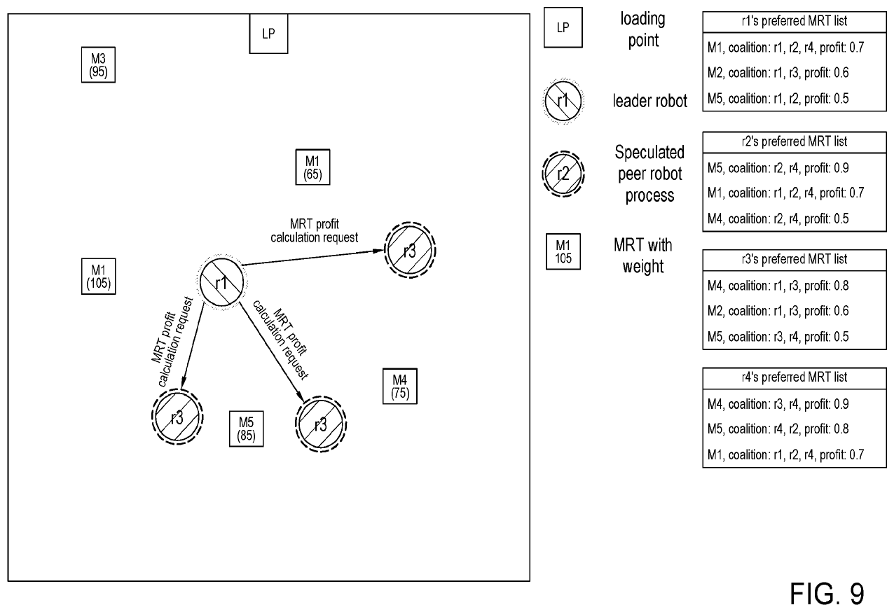

FIG. 9 shows an example of MRT profit calculation process. Robot r1 is assumed to be the leader robot, and robots r2, r3, and r4 are the participating peer robots. The payload of each robot is limited to 50 kg. The number of robots required by each MRT Nⱼ is calculated as shown in equation 11, where Wⱼ is the weight of the MRT and pᵢ is the maximum payload of robot rᵢ.

$$\text{?} = \text{?} \frac{\text{?}}{\text{?}} \text{?} \qquad ( 11 )$$

$$\text{?} \text{indicates text missing or illegible when filed}$$

Robots first select their preferred MRTs. For leader robot r1, the preferred MRTs are M1, M2, and M5. For every preferred MRT, participating robots calculate the benefits of different combinations of coalitions (containing the robot itself) to execute it. For M1 in r1's preferred MRT list, robot r1 can gain the highest profit value 0.7 in cooperation with robot r2 and r4 according to equation 8. The same calculation process is performed for the other preferred MRTs. After sorting, the preferred MRT list of every participating robot is shown in FIG. 9.

### Consultation

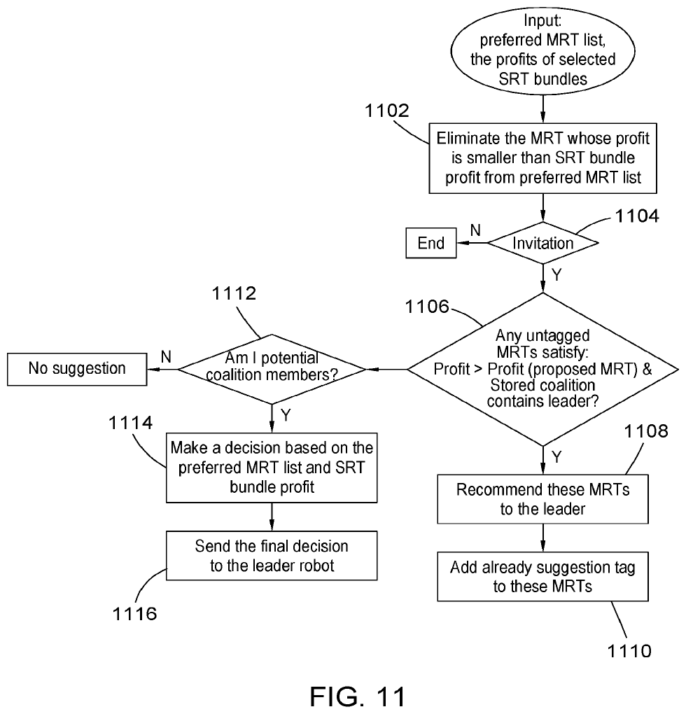

After the preferred MRT list construction and SRT bundle construction process, a method is performed as shown in FIG. 11. The leader robot first removes any MRTs whose profit is smaller than the SRT bundle profit from the preferred MRT list 1102. The calculation process can be expressed by equation 12, where profitBundle(rᵢ, Bⁱ) and profitCoalition(tₖ, Cₖ, Pₖ) are calculated through equation 5 and equation 8. If the difference is below 0, then the MRT is kept, otherwise, it will be removed from preferred MRT list. The same elimination process happens in the participating peer robots.

$$diff = \text{?} ( profitBundle ( {r}_{i} , {B}^{i} ) - profitCoalition ( {t}_{k} , {C}_{k} , {P}_{k} ) ) \qquad ( 12 )$$

$$\text{?} \text{indicates text missing or illegible when filed}$$

After the elimination process, the leader robot checks whether the preferred MRT list is empty. If the preferred MRT list is empty, this means that the leader robot cannot find appropriate partners to perform the MRTs, or any appropriate MRTs to perform. Then the leader robot checks whether the selected SRT bundle compiled for itself is empty. If yes, the final decision making is for the leader robot to return to the idle state. If no, the leader robot's final decision is to execute the SRT bundle. If the preferred MRT list is not empty, the leader robot selects the top ranked MRT in the preferred MRT list and sends an invitation message (including potential coalition members, profit, selected MRT) to the participating peer robots 1104. The participating robots are divided into two kinds, potential coalition members and other peer robots.

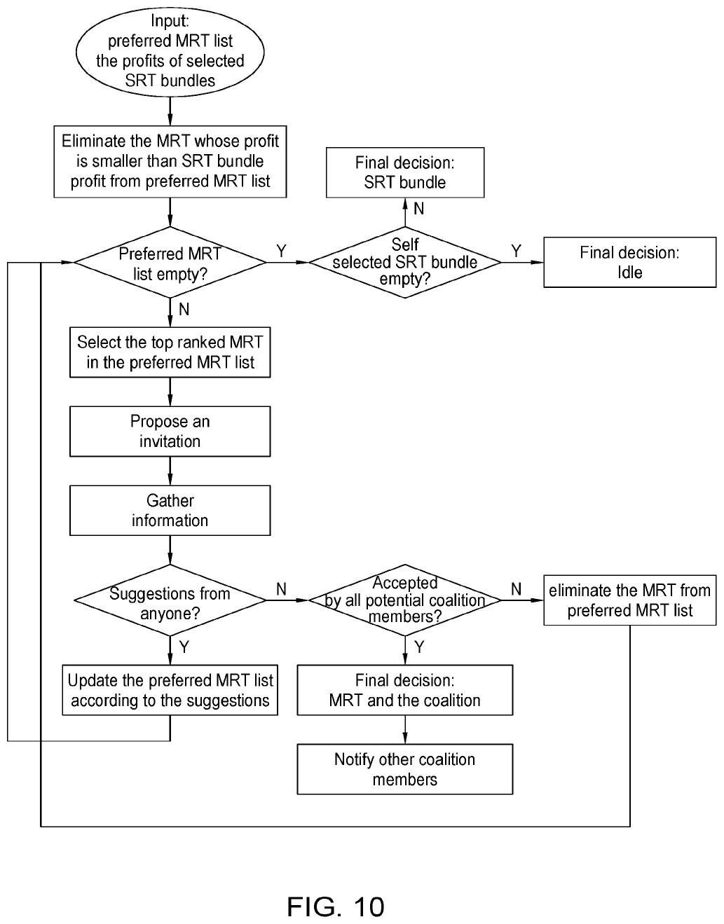

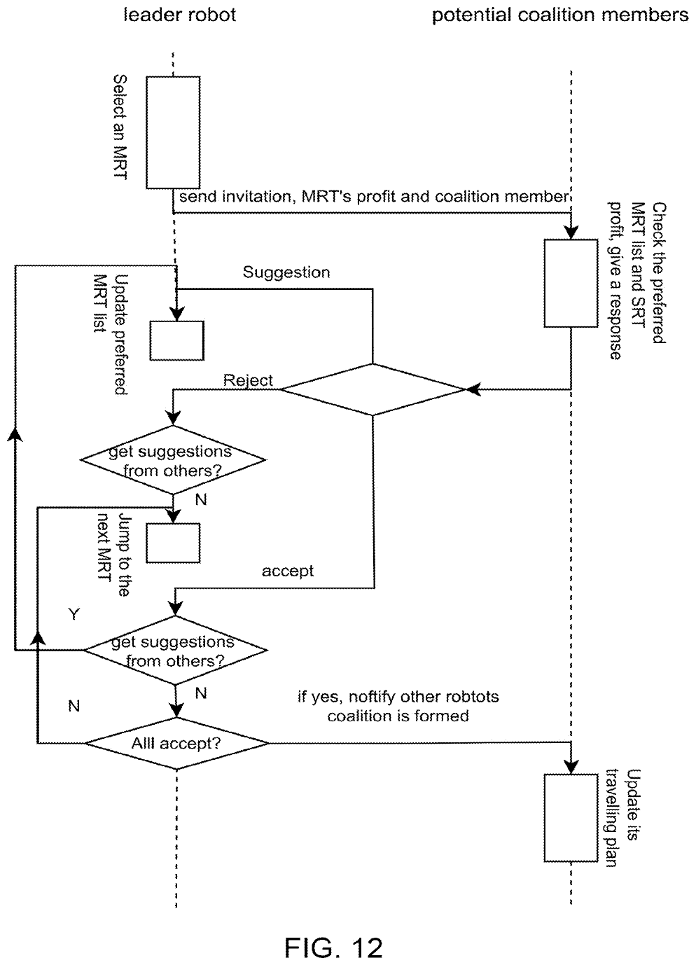

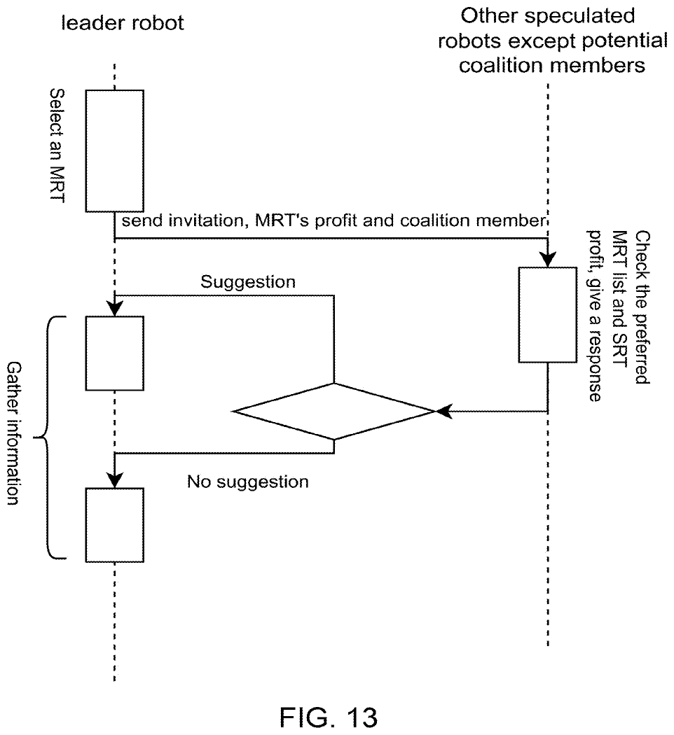

FIGS. 12 and 13 describe the interaction between the leader robot and the potential coalition members, and between the leader robot and the peer robots excluding the potential coalition members. After receiving the invitation, the potential coalition members have three possible responses (suggestion, accept and reject). Other participating robots only have suggestion options. The behaviours of the potential coalition members after receiving the invitation are shown in FIG. 10. The peer robots' responses reduce the computation bias of the leader robot.

After receiving the invitation message from the leader robot, the participating peer robots check whether there are any MRTs preferred by the peer robots that have not been suggested to the leader robot satisfying two conditions simultaneously: (1) the calculated profit of the MRT preferred by the peer robot is higher for a coalition of robots proposed by the peer robot than for a coalition of robots for an MRT proposed by the leader robot, or for a coalition of robots proposed by the leader robot for the same MRT as that proposed by the peer robot; (2) the coalition of robots proposed by the peer robot contains the leader robot 1106. If there are any MRTs satisfying these two conditions, the participating robot sends suggestions to the leader robot to suggest additional or alternative peer robots to join the coalitions to perform the MRTs 1110.

If no MRT in the preferred MRT list satisfies these conditions, then the peer robot checks whether it belongs to a potential coalition proposed by the leader robot 1112. If it is not a potential coalition member, it does not need to send a suggestion response. If it is a potential coalition member, the peer robot calculates a possibility that it will accept the invitation Pbₐ according to equation 13, where Pᵢₙᵥ is the profit of a selected MRT in the invitation, PMᵢ is the profit set of robot rᵢ's preferred MRT list, and profitBundle is the profit for peer robot n to execute the selected SRT bundle 1114. The other preferred MRTs and the selected SRT bundle will be the basis for the robot to make an accept or reject decision.

$${Pb}_{a} = \frac{\text{?}}{max ( profitBundle , \text{?} )} \qquad ( 13 )$$

$$\text{?} \text{indicates text missing or illegible when filed}$$

After gathering responses from all participating peer robots, the leader robot first checks whether it has received any suggestions. If it receives any suggestions, the leader robot updates its preferred MRT list according to the suggestion and begins a new iteration of invitations to participate in the coalition. The suggestion is always given the highest priority among other responses because it can provide the leader robot with better choices and eliminate computational bias. If there are no suggestions, the leader robot checks whether any potential coalition members have rejected the invitation. If none of the proposed peer robots rejects the invitation, the coalition is formed. If there are no more MRTs to be allocated, the leader robot notifies the coalition members that the coalition has been formed and the task allocation process ends. If there are further MRTs to be allocated, the leader robot eliminates the MRT for which a coalition has been formed from the preferred MRT list and begins the new iteration of the MRT allocation process by checking whether the preferred MRT list is empty.

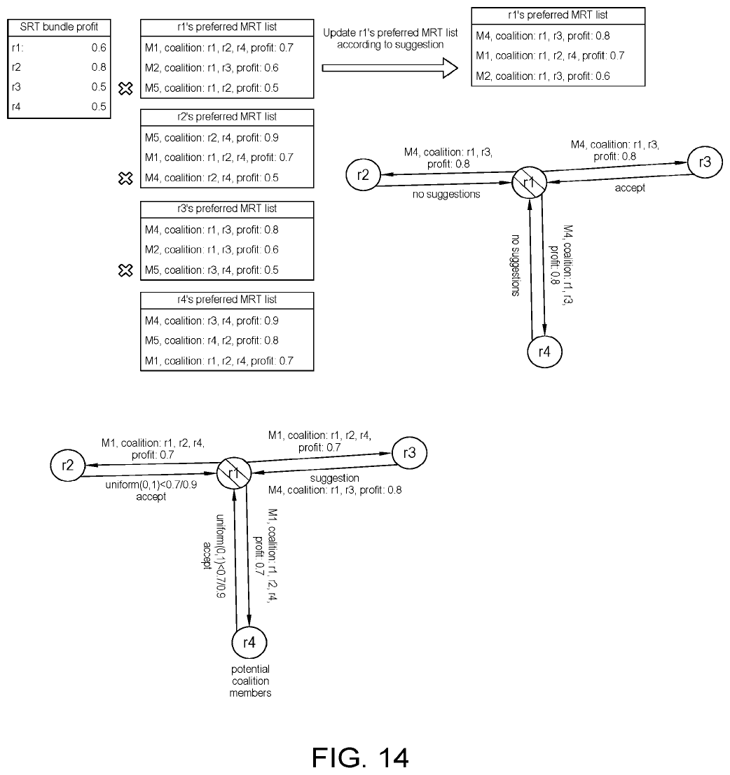

FIG. 14 gives an example of the interaction between the leader robot and participating peer robots during a consultation process. First, the participating robots remove any MRTs whose coalition profit is smaller than the SRT profit according to equation 14. For example, M5 in the robot r1's preferred MRT list is deleted, because the return for r1 and r2 executing SRTs is higher than the return on the MRT M5. Then the leader robot r1 selects and sends the selection of the task M1, whose profit is the highest in its preferred MRT list, to robots r2, r3, and r4. After comparing this coalition with its own preferred MRT list and SRT profit, robot r3 provides a suggestion to the leader robot. The task M4 can be finished by robots r1 and r3 with a profit value of 0.8. Robot r2 has no suggestion and it belongs to the potential coalition. According to equation 14, the probability of r2 accepting the invitation is 7/9. After generating a random number from 0 to 1 consistent with the uniform distribution, the number is smaller than 7/9 and the robot accepts the invitation. The same process happens under robot r4. After gathering information from all participating peer robots, the leader robot r1 updates its preferred MRT list according to the suggestion from robot r3. The updated preferred MRT list of r1 is shown in FIG. 14. Then robot r1 selects the top ranked MRT M4 and sends an invitation to all participating peer robots. Robots r2 and r4 are not potential coalition members. After checking their preferred MRT list, they send no suggestion response to the leader robot. As for robot r3, the probability of accepting the invitation is 100% according to equation 14. After robot r1 gathers all of the required information from the peer robots, the coalition is formed. The final decision of leader robot r1 is to execute the task M4 with robot r3.

The consultation part introduces a new interactive structure mode between a leader robot and participating peer robots, which can reduce the computation on every robot and eliminate the computational bias caused by the preferred MRT lists. Additionally previously calculated SRT and MRT profits can act as a reference to help peer robots to provide a better response to the leader robot's MRT invitation. The probabilistic decision-making process increases the robustness and scalability of the algorithm in a dynamic environment.

The proposed method can solve the capacitated vehicle routing problem and collective transport problem at the same time. It balances the selection between SRTs and MRTs, which can minimise the waiting time among robots and improve system efficiency.

### Example 1

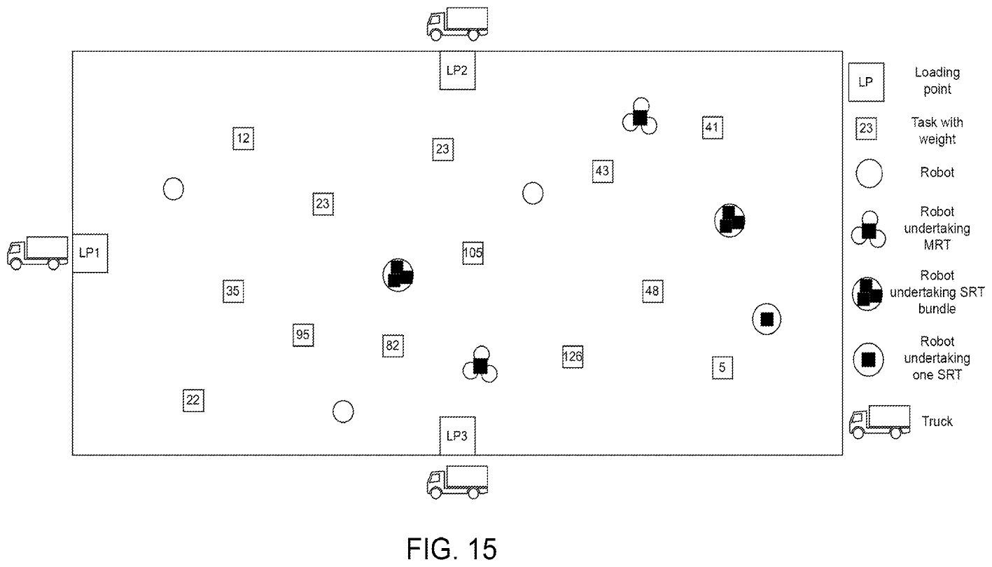

As shown in FIG. 15, the shape of a simulated warehouse environment is a rectangle. The length (l) and width (w) are 300 m and 100 m respectively. There are three loading points in the warehouse. The trucks come to loading points consecutively, with no time space between trucks in the schedule at the same loading points. The payload of each of a plurality of robots is set at 50 kg. The maximum weight of a parcel is set to 150 kg, which means the maximum number of robots needed for a single task is 3. The average speed v of the robot is set to 1 m/s. Trucks have a scheduled arrival time and departure time. At every loading point (LP), at most one truck can be served, so only when one truck departs can the next truck arrive. The truck's actual arrival time might be delayed because the tasks on the former truck at the same LP are not finished on time. Additionally, it is assumed that the arrival time will not be earlier than the scheduled arrival time. Even if the tasks on the former trucks are finished before the deadline, the next truck on the same LP will not come in advance. The truck's waiting time is proportional to the number of SRTs (Nₛ) and MRTs (Nₘ) in it. Robots are initially randomly distributed in the warehouse. Trucks will initially post some percentage of tasks as soon as they reach the loading point and will dynamically post some tasks before the scheduled departure time. In the simulated task allocation environment, there are several parameters that need to be configured, such as the number of SRTs and MRTs per truck, the proportion of initially and gradually posted tasks, the number of trucks per loading point, the number of robots in the warehouse, and the parameter a relevant to trucks' waiting time. The tasks' pickup positions are generated randomly in the warehouse. The appearance time of gradually posted tasks is generated randomly. The appearance time of initially posted tasks is set to the arrival time of the truck. The tasks' deadline can be set to the scheduled departure time of the truck.

As illustrated in the operational difference section, all the parameters of the proposed method including k₁˜k₆, need to be adjusted to improve the performance of the proposed method. Prior to conducting the following comparison experiments, the parameters are optimised using optimisation methods like genetic algorithm (GA) in a random and highly dynamic environment.

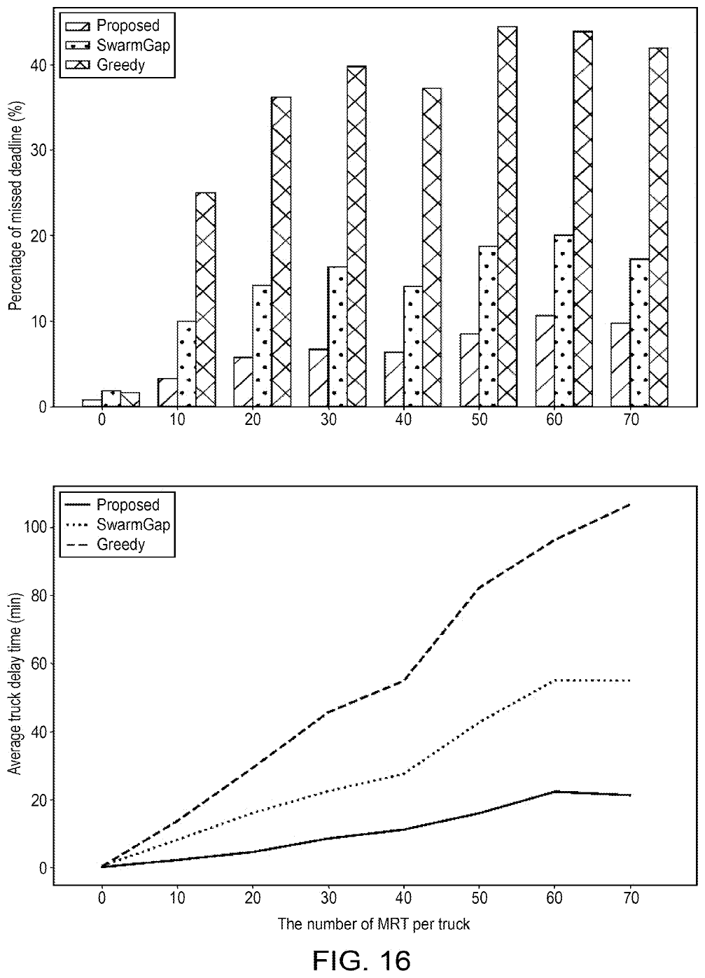

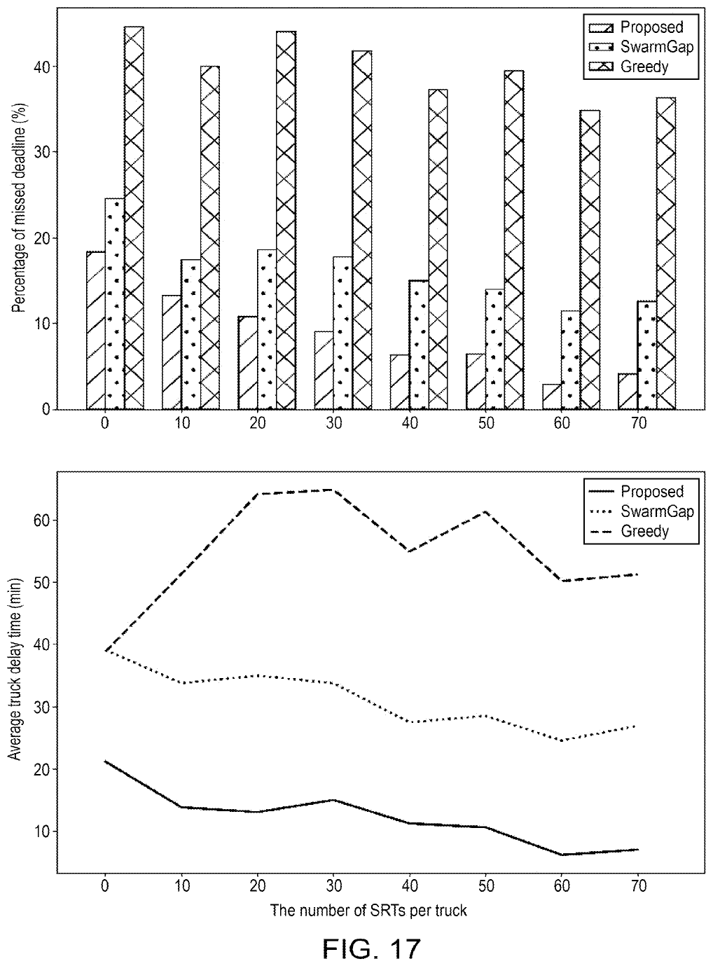

FIG. 16 and FIG. 17 are graphs showing the performance of algorithms under different proportions of SRTs and MRTs. The simulated environment configuration of FIG. 16 is detailed in Table 3. The percentage of missed deadlines and average truck delay time is set as an evaluation metric. The average truck delay time is the difference between the scheduled departure time and the actual departure time. The number of SRTs is fixed to 40, The number of MRTs varies. It can be concluded from FIG. 17, the proposed algorithm has a lower deadline missing percentage and less truck delay time under the same circumstances compared with the state-of-art work (Swarm-GAP-based method) and a greedy method. In the greedy method, the robots decide on task selection during an idle state. Given the higher resource demand for MRTs, MRTs are given priority in allocation.

Robots will execute their MRT allocation when feasible, continuing until no MRTs are available or only SRTs exceed deadlines. When selecting SRTs, robots choose tasks with the greatest profit, as defined by Eqn. 2. For MRT allocation, robots compute profit for all MRTs and potential coalitions using Eqn. 7, then opt for the MRT and coalition yielding the highest profit. An outline of the Swarm-GAP-based method can be found in Dos Santos, Fernando, and Ana L C Bazzan. “Towards efficient multiagent task allocation in the robocup rescue: a biologically-inspired approach.” Autonomous Agents and Multi-Agent Systems 22 (2011): 465-486. The simulation environment of FIG. 17 is detailed in Table 4. The number of MRTs per truck is fixed at 40, the SRTs per truck varies. In conclusion, under the same condition, the proposed algorithm works better than the other two algorithms.

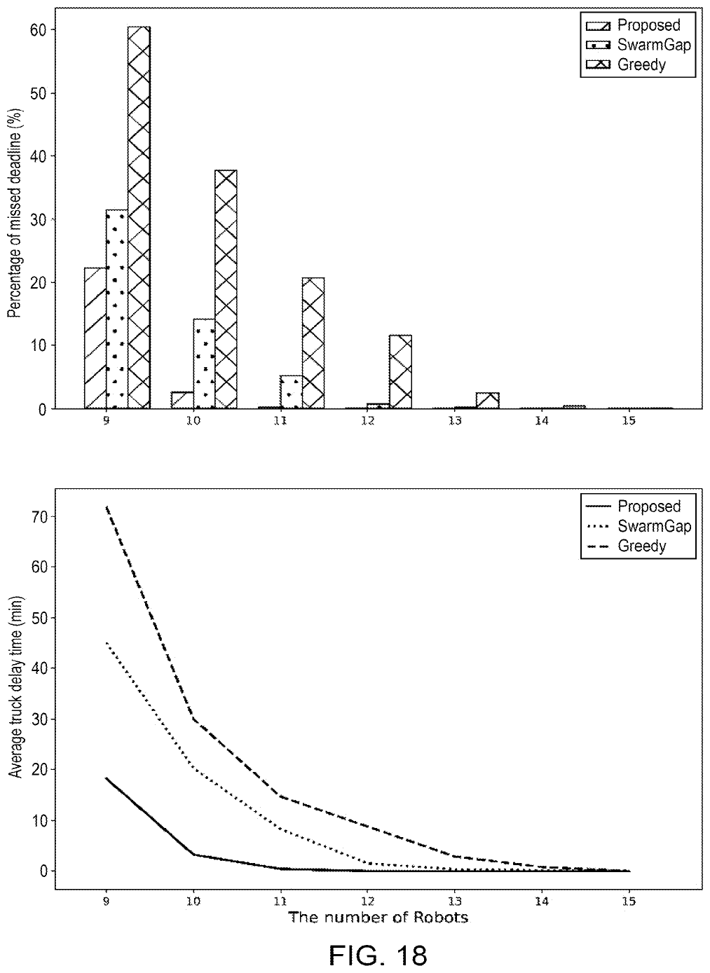

FIG. 18 shows a comparison for the configuration shown in Table 5. The incoming SRTs and MRTs per truck are generated randomly from 20 to 50. The number of robots in the team varies. FIG. 18 shows a comparison when testing the performance of algorithms with the different numbers of robots in the team. It can be concluded that the proposed algorithm requires two fewer robots to finish all the tasks within the deadline compared with the Swarm-GAP-based method.

TABLE 3
Simulation Configuration for FIG. 16

| | |
|---|---|
| Average truck per loading point | 3 |
| The number of participating robots | 6 |
| The number of robots in the warehouse | 10 |
| The number of SRTs per truck | 40 |
| The percentage of gradually posted tasks per truck (%) | Uniform(20, 30) |

TABLE 4
Simulation Configuration for FIG. 17

| | |
|---|---|
| Average truck per loading point | 3 |
| The number of participating robots | 6 |
| The number of robots in the warehouse | 10 |
| The number of MRTs per truck | 40 |
| The percentage of gradually posted tasks per truck (%) | Uniform(20, 30) |

TABLE 5
Simulation Configuration for FIG. 18

| | |
|---|---|
| Average truck per loading point | 3 |
| The number of participating robots | 6 |
| The number of SRTs per truck | uniform(20, 50) |
| The number of MRTs per truck | uniform(20, 50) |
| The percentage of gradually posted tasks per truck (%) | uniform(20, 30) |

Whilst certain embodiments have been described, these embodiments have been presented by way of example only, and are not intended to limit the scope of the inventions. Indeed, the novel devices, and methods described herein may be embodied in a variety of other forms; furthermore, various omissions, substitutions and changes in the form of the devices, methods and products described herein may be made without departing from the spirit of the inventions. The accompanying claims and their equivalents are intended to cover such forms or modifications as would fall within the scope and spirit of the inventions.

1. A decentralised multi-robot task allocation method comprising:
performing, by a first robot of a plurality of robots, the steps of:
obtaining information regarding a new task comprising at least one single robot task, SRT, and at least one multi-robot task, MRT;
determining which SRTs each remaining robot of the plurality of robots is likely to select;
determining a preferred MRT for the first robot to perform, and potential coalition partners for performing the preferred MRT with the first robot;
consulting with the remaining robots of the plurality of robots to determine a coalition of robots including the first robot to perform an MRT of the at least one MRT; and
performing at least one of the at least one SRT or the at least one MRT based on the determination of which SRTs each robot from the subset of robots is likely to select, the determination of which MRTs each robot from the subset of robots is likely to select, and the consultation.

2. A method according to claim 1, the method further comprising performing, by the first robot, the steps of:
requesting information on available time resources from the remaining robots of the plurality of robots; and
selecting a subset of robots from the plurality of robots based on the available time resources of the remaining robot of the plurality of robots.

3. A method according to claim 1, the method further comprising performing, by the first robot, the steps of:
requesting token information from the plurality of robots; and
receiving a token, from a current token holder of the plurality of robots, indicating that the first robot is permitted to initiate task allocation.

4. A method according to claim 1, wherein the first robot is configured to seek a new task in response to either the first robot having completed its assigned subtasks, or, if the first robot is in an idle state, in response to status of the other robots or tasks changing.

5. A method according to claim 1, wherein only one robot from the plurality of robots can initiate task allocation at a given time.

6. A method according to claim 1, wherein determining which SRTs each robot from the remaining robots of the plurality of robots is likely to select comprises:
requesting preferred SRTs from the task from each of the plurality of robots; and
receiving, from each of the subset of robots, information on the preferred SRTs from the task.

7. A method according to claim 1, wherein the determination of which SRTs, each remaining robot of the plurality of robots is likely to perform is based on information on the SRT, wherein the information on the SRT comprises at least one of: deadline information; weight; pick-up point; and delivery point.

8. A method according to claim 1, wherein the selection of robots from the remaining robots of the plurality of robots to perform the at least one SRT comprises an iterative process of matching each SRT to a robot, wherein in each iteration, at most one SRT is assigned to each robot.

9. A method according to claim 6, wherein the preferred SRTs for each robot are determined based on a profit calculation performed by each respective robot.

10. A method according to claim 1, wherein the determination of which MRT and coalition partners the first robot is likely to select comprises requesting a preferred MRT, a profit calculation for the preferred MRT, and preferred coalition partners for the preferred MRT from each of the plurality of robots.

11. A method according to claim 1, wherein consulting with the remaining robots of the plurality of robots comprises:
sending an invitation to each robot of the plurality of robots comprising a preferred MRT, a required coalition partner, and an MRT profit;
receiving a suggestion of an alternative MRT for the first robot to perform; and
adding the alternative MRT to the preferred MRTs for the first robot to perform.

12. A method according to claim 11, further comprising executing an MRT, wherein the MRT is only executed if each robot required to be part of the coalition accepts an invitation to execute the MRT.

13. A method according to claim 11, further comprising performing, by each of the remaining robots of the plurality of robots:
responding to the invitation of the first robot by: (i) accepting the invitation, (ii) rejecting the invitation, or (iii) providing a suggestion of an alternative MRT for the first robot to perform,
wherein the suggestion of an alternative MRT to perform includes at least one of a previously unsuggested MRT yielding higher profits than for the preferred MRTs of the first robot, an optimal coalition for performing the alternative MRT, including the first robot and the robot providing the suggestion, or an associated profit value for the alternative MRT.

14. A multi-agent system comprising:
a plurality of robots, comprising a first robot,
the first robot comprising a processor and a memory storing instructions that can be executed by the processor, the instructions, when executed by the processor, causing the processor to:
obtain information regarding a new task comprising at least one single robot task, SRT, and at least one multi-robot task, MRT;
determine which SRTs each remaining robot of the plurality of robots is likely to select;
determine a preferred MRT for the first robot to perform, and potential coalition partners for performing the preferred MRT with the first robot;
consult with the remaining robots of the plurality of robots to determine a coalition of robots including the first robot to perform an MRT of the at least one MRT; and
performing at least one of the at least one SRT or the at least one MRT based on the determination of which SRTs each robot from the subset of robots is likely to select, the determination of which MRTs each robot from the subset of robots is likely to select, and the consultation.

15. A multi-agent system according to claim 11, wherein the instructions further cause the processor to:
request information on available time resources from the remaining robots of the plurality of robots; and
select a subset of robots from the plurality of robots based on the available time resources of the remaining robots of the plurality of robots.

16. A multi-agent system according to claim 11, wherein the instructions further cause the processor to:
request token information from the plurality of robots; and
receive a token, from a current token holder of the plurality of robots, indicating that the first robot is permitted to initiate task allocation.

17. A multi-agent system according to claim 11, wherein the instructions further cause the processor to seek a new task in response to either the first robot having completed its assigned tasks, or, if the first robot is in an idle state, in response to status of the other robots of the plurality of robots or tasks changing.

18. A multi-agent system according to claim 11, wherein determining which SRTs each robot from the wherein remaining robots of the plurality of robots is likely to select comprises:
requesting preferred SRTs from the task from each of the robots of the plurality of robots; and
receiving, from each of the robots of the plurality of robots, information on the preferred SRTs from the task.

19. A multi-agent system according to claim 11, wherein the selection of robots from the remaining robots of the plurality of robots to perform the at least one SRT comprises an iterative process of matching each SRT to a robot, wherein in each iteration, at most one SRT is assigned to each robot.

20. A multi-agent system according to claim 11, wherein the determination of which MRTs each remaining robot of the plurality of robots is likely to select comprises requesting a preferred MRT, a profit calculation for the preferred MRT, and preferred coalition partners for the preferred MRT from each of the plurality of robots
